(19) United States
(12) Patent Application Publication
(10) Pub. No.: US 2014/0162121 A1
(43) Pub. Date: Jun. 12, 2014

(54) POWDER FOR CATHODE OF LITHIUM-SULFUR SECONDARY BATTERY AND METHOD OF FABRICATING THE SAME

(71) Applicant: HYUNDAI MOTOR COMPANY, Seoul (KR)

(72) Inventors: Hee Yeon Ryu, Yongin (KR); Hee Jin Woo, Uiwang (KR)

(73) Assignee: HYUNDAI MOTOR COMPANY, Seoul (KR)

(21) Appl. No.: 13/855,170

(22) Filed: Apr. 2, 2013

(30) Foreign Application Priority Data
Dec. 12, 2012 (KR) 10-2012-0144397

(51) Int. Cl. H01M 4/36

(52) U.S. Cl. CPC H01M 4/366
USPC 429/212; 427/58

(57) ABSTRACT

Provided is powder for a cathode of a lithium-sulfur secondary battery that maximizes the utilization rate of sulfur by increasing the ratio of sulfur and an absolute content of sulfur, increases the capacity of the lithium-sulfur secondary battery and improves energy density and life-span characteristics, and a method of fabricating the same. The provided powder comprises a fibrous conductive material inserted in and penetrating a sulfur powder, a nano sized spherical conductive material coated on a surface of the sulfur powder to surround the surface of the sulfur powder, and a conductive polymer protective film is coated on an outer surface of the coated spherical conductive material layer.

### CROSS-REFERENCE TO RELATED PATENT APPLICATION

This application claims the benefit of Korean Patent Application No. 10-2012-0144397, filed on Dec. 12, 2012 in the Korean Intellectual Property Office, the disclosure of which is incorporated herein in its entirety by reference.

### BACKGROUND OF THE INVENTION

1. Field of the Invention

The present invention relates to a cathode of a lithium-sulfur secondary battery, and more particularly, to powder for a cathode of a lithium-sulfur secondary battery and a method of fabricating the same. More particularly, the present invention relates to a powder that maximizes the utilization rate of sulfur, particularly by increasing the ratio of sulfur with respect to the entire cathode active material and an absolute content of sulfur. The powder further increases the capacity of the lithium-sulfur secondary battery and improves energy density and life-span characteristics of the lithium-sulfur secondary battery.

2. Description of the Related Art

Chargeable/dischargeable secondary batteries are widely used as large-capacity power storing batteries used in an electric vehicle, a power saving system, or a small-sized high-performance energy source for a portable electronic device, such as a mobile phone, a camcorder, or a laptop computer.

Lithium ion batteries as secondary batteries have relatively high energy density and relatively large capacity per unit area compared to nickel-manganese batteries and nickel-cadmium batteries.

Further, due to their low self-discharge rate, long life span and lack of memory effect, lithium batteries are preferable and are convenient to use.

However, lithium ion batteries have several problems when used as batteries for next generation electric vehicles. In particular, they lack stability due to low energy density and low output characteristics.

In order to address these problems of lithium ion batteries, studies have been made towards the development of lithium-sulfur secondary batteries or lithium-air secondary batteries that may realize high output and high energy density.

Also, lithium-sulfur secondary batteries use sulfur as a cathode active material, use lithium as an anode, and are high-capacity batteries having a theoretical capacity of 1675 mAh/g with a potential of about 2.1 V.

Since these lithium-sulfur secondary batteries have much higher theoretical capacities and energy densities than existing lithium ion batteries, they are suitable for use as batteries for electric vehicles that require high output and high energy density.

Further, sulfur which is used as the cathode active material in lithium-sulfur secondary batteries exists in the earth and, thus, is inexpensive and has good price stability.

However, sulfur has electric non-conductor characteristics. As such, sulfur must be in contact with a material having high electrical conductivity, such as carbon, to be used as an active material of a secondary battery electrode.

According to the related art, lithium-sulfur secondary batteries have been made in which sulfur and Ketjenblack® (manufactured by the Ketjen Black International Company), Super C® (manufactured by the Timcal Graphite & Carbon Inc.), Super P® (manufactured by the Timcal Graphite & Carbon Inc.), a carbon material, such as vapor grown carbon fiber (VGCF) or carbon nanotubes (CNTs), or a binder, such as polyvinylidene fluoride (PVdF) or poly(vinylidene fluoride-co-hexafluoropropylene) (PVdF-co-HEP), are put in a mechanical milling device, such as a ball mill, are mixed in a dry or wet manner to produce a slurry which is used for an electrode.

However, such lithium-sulfur secondary batteries have short life-span characteristics due to dissolution and mobility of polysulfide that is generated when a discharge reaction with electrolytes takes place.

Examples have recently been reported in which life-span characteristics of lithium-sulfur secondary batteries are improved by using a molten sulfur-carbon composite in which sulfur melted at a melting point of 115° C. or higher is inserted in a carbon material having many pores and porosity, such as mesoporous carbon CMK-3 or expanded graphite.

Further, studies have been carried out to further improve life-span characteristics of lithium-sulfur secondary batteries by coating the structure with conductive polymer.

However, in the molten sulfur-carbon composite in which sulfur is melted, the sulfur is inserted only in a porous portion of the carbon material. Thus, when the molten sulfur-carbon composite is used, the absolute content of sulfur insufficiently makes use of the advantages of lithium-sulfur secondary batteries having theoretically high energy density. Thus, a method for increasing the content of sulfur in lithium-sulfur secondary batteries is required.

### SUMMARY OF THE INVENTION

The present invention provides powder for a cathode of a lithium-sulfur secondary battery and a method of fabricating the same. More particularly, the present invention provides powder for a cathode of a lithium-sulfur secondary battery that is capable of maximizing the utilization rate of sulfur, particularly by increasing the ratio of sulfur with respect to the entire cathode active material and by increasing the absolute content of sulfur. The present invention further provides powder for a cathode of a lithium-sulfur secondary battery that increases the capacity of the lithium-sulfur secondary battery and improves energy density and life-span characteristics of the lithium-sulfur secondary battery.

According to various embodiments, the present invention provides powder for a cathode of a lithium-sulfur secondary battery that is capable of maximizing the electrical conductivity and the utilization rate of a sulfur charge/discharge reaction of the cathode active material structure, and a method of fabricating the same.

The present invention also provides powder for a cathode of a lithium-sulfur secondary battery that improves charge/discharge life-span characteristics of the lithium-sulfur secondary battery, particularly by suppressing a loss of polysulfide that is generated due to a discharge reaction of the lithium-sulfur secondary battery.

According to an aspect of the present invention, powder for a cathode of a lithium-sulfur secondary battery is provided comprising, a fibrous conductive material inserted in a sulfur powder so as to penetrate the sulfur powder, a spherical conductive material having a nano size coated on a surface of the sulfur powder (which the fibrous conductive material penetrates) such that the spherical conductive material surrounds the surface of the sulfur powder, and a conductive polymer protective film coated on an outer surface of the coated spherical conductive material layer.

According to another aspect of the present invention, a method of fabricating powder for a cathode of a lithium-sulfur secondary battery is provided, the method including: mixing a sulfur powder and a fibrous conductive material to fabricate a sulfur and fibrous conductive material mixture powder in which the fibrous conductive material is inserted in the sulfur powder and penetrates the sulfur powder; coating a spherical conductive material having a nano size on a surface of the sulfur powder to fabricate a sulfur and heterogeneous conductive material mixture-coating powder in which a spherical conductive material layer surrounds the sulfur powder; and coating a conducive polymer protective film on an outer surface of the spherical conductive material layer.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 are schematic views of a composition of powder for a cathode of a lithium-sulfur secondary battery according to an exemplary embodiment of the present invention; and

FIGS. 3 and 4 illustrate a method of fabricating the powder illustrated in FIG. 1 or 2, according to exemplary embodiments of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

The present invention will now be described more fully with reference to the accompanying drawings, in which exemplary embodiments of the invention are shown so that one of ordinary skill in the art can easily embody the invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

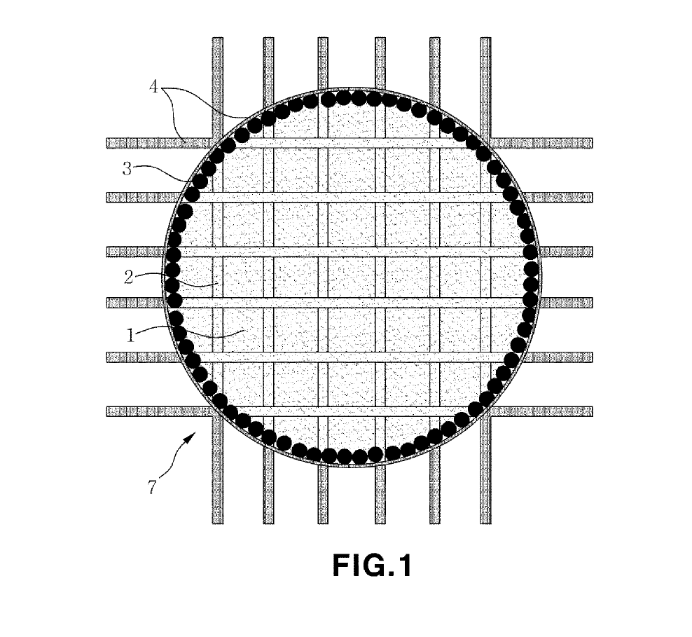

FIG. 1 is a schematic view of a composition of powder for a cathode of a lithium-sulfur secondary battery according to an exemplary embodiment of the present invention. FIG. 1 illustrates a composition of powder 7 in which sulfur and heterogeneous conductive material mixture-coating powder is coated with conductive polymer.

According to aspects of the present invention, powder for a cathode of a lithium-sulfur secondary battery is provided that increases and may maximize the utilization rate of sulfur by increasing the ratio of sulfur with respect to the entire cathode active material and by further increasing an absolute content of sulfur. The present invention further provides powder for a cathode of a lithium-sulfur secondary battery that increases the capacity of the lithium-sulfur secondary battery and that further improves energy density and life-span characteristics of the lithium-sulfur secondary battery. Further provided is a method of fabricating the powder for a cathode of a lithium-sulfur secondary battery.

In particular, according to various embodiments, the present invention provides a new type of powder for a cathode of a lithium-sulfur secondary battery in which heterogeneous conductive materials (i.e., a plurality of conductive materials having different forms/shapes) are stepwise mixed and then coated with a sulfur powder by using a suitable method taking into consideration the characteristics of the multiple forms of the materials. Subsequently, the surface of the sulfur coated heterogeneous conductive material powder is coated with a conductive polymer, preferably in the form of a thin film.

According to one embodiment, the heterogeneous conductive materials include a rod shaped conductive material and a spherical shaped conductive material. In particular, a first conductive material may be a fibrous conductive material in the form of a rod having a high aspect ratio and a second conductive material may be in the form of a spherical conductive material. In this form, the rod shaped fibrous conductive material is mixed with sulfur power and is inserted therein, while the spherical conductive material coats the surface of the sulfur and fibrous conductive material mixture powder. Of course, the heterogeneous conductive materials are not limited to only combinations of rod and spherical shaped materials, and any other combination of different shapes can alternatively be provided.

In this case, after the rod shaped fibrous conductive material is inserted in the sulfur powder, the surface of the sulfur and fibrous conductive material mixture power is then coated with the spherical conductive material. Preferably, the spherical conductive material is nano sized, i.e., a powder conductive material. Subsequently, the surface of the sulfur and heterogeneous conductive material mixture-coating powder is coated with a conductive polymer so that a final powder, i.e., the sulfur and heterogeneous conductive material mixture-coating powder 7 including a conductive polymer protective film, is formed.

The sulfur and heterogeneous conductive material mixture-coating powder 7 represents a structure in which a fibrous conductive material 2 in the form of a rod having a high aspect ratio penetrates the sulfur powder 1 and is inserted in the sulfur powder 1, as illustrated in FIG. 1, is then surrounded by the spherical conductive material 3 having a nano size. As further illustrated, the surface of the fibrous conductive material 2 that protrudes outwardly (i.e., beyond the spherical conductive material 3) and an outer surface of the spherical conductive material 3 are then surrounded by a conductive polymer protective film 4. The spherical conductive material 3 may completely surround the sulfur powder 1 having the fibrous conductive material 2 inserted therein or one or more portions of the sulfur powder 1 having the fibrous conductive material 2 inserted therein may not be completely surrounded. Further, the conductive polymer protective film 4 may completely surround and encapsulate the spherical conductive material 3 which completely or partially surrounds the sulfur powder 1 having the fibrous conductive material 2 inserted therein.

In the above-described structure, by performing a fabrication process of stepwise mixing and coating the sulfur powder 1 with heterogeneous conductive materials 2 and 3, the fibrous conductive material 2 is inserted within the sulfur (including the center of the sulfur powder), and an outside surface of the sulfur powder 1 is surrounded by another conductive material 3 so that electrical conductivity can be uniformly exerted deep within the entire sulfur powder. Thus, the utilization rate of sulfur can be maximized, and an initial capacity of the lithium-sulfur secondary battery can be increased close to a theoretical capacity thereof.

Also, the conductive polymer protective film 4 is coated on the structure which includes the sulfur powder 1, the fibrous conductive material 2, and the spherical conductive material 3, such that the possibility that polysulfide may react with an anode can be minimized, and the life-span of the lithium-sulfur secondary battery is improved.

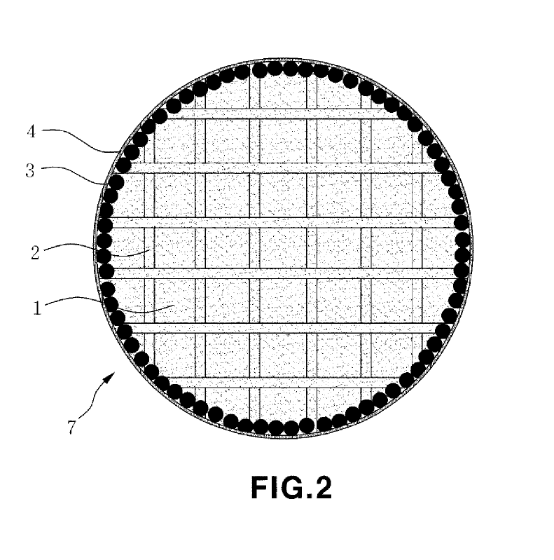

In this way, an example of the sulfur and heterogeneous conducive material mixture-coating powder 7 including the conductive polymer protective film 4, will be described in more detail with reference to FIGS. 1 and 2.

FIG. 1 illustrates an example of powder in which the fibrous conductive material 2 inserted in the sulfur powder 1 penetrates the sulfur powder 1 and part of the fibrous conductive material 2 protrudes beyond an outside of the spherical conductive material 3 (as shown by the rod-like portions extending beyond the spherical conductive material 3). FIG. 2 illustrates an example of powder in which the fibrous conductive material 2 inserted in the sulfur powder 1 penetrates the sulfur powder 1 and is completely disposed within the sulfur powder 1 without protruding beyond the outside of the spherical conductive material 3.

According to one embodiment, the sulfur is powder 1 in the form of a plurality of particles of generally spherical shape having a diameter of about 1 to 150 μm and provided in a lump form, and the fibrous conductive material 2 is a carbon material. In this case, the fibrous conductive material 2 that penetrates the sulfur powder 1 and that is inserted in the sulfur powder 1, may be carbon fiber having an aspect ratio of about 6 to about 600, for example, carbon fiber having a diameter of about 50 to 300 nm and a length of about 2 to 30 μm.

Here, if the aspect ratio of the fibrous conductive material 2 is less than 6, it is difficult to maintain a form that penetrates the sulfur and, thus, is not preferable. On the other hand, if the aspect ratio of the fibrous conductive material 2 exceeds 600, there is a tendency of the fibrous conductive material 2 to surround the sulfur rather than penetrate it and, thus, is not preferable.

According to various embodiments, the carbon fiber is vapor grown carbon fiber (VGCF).

The fibrous conductive material (e.g., VGCF) 2 penetrates the sulfur powder 1, which is in the form of a sphere or lump, and is inserted therein. Thus, the fibrous conductive material 2 is connected to the sulfur power 1. In this case, part of the fibrous conductive material 2 may protrude outwardly from the surface of the sulfur powder 1, as illustrated in FIG. 1, or the entire fibrous conductive material 2 may be inserted only in the sulfur powder 1 without protruding outwardly, as illustrated in FIG. 2.

In the powder 7 in which sulfur and the fibrous conductive material are mixed, another conductive material is disposed so as to coat and surround the outer surface of the sulfur powder 1. For example, the spherical conductive material 3 may comprise one, or two or more conductive powders having a nano size, such as a carbon material in the form of a spherical powder and having a particle size of about 10 to 80 nm, selected from the group consisting of Super C® (manufactured by the Timcal Graphite & Carbon Inc.), Super P® (manufactured by the Timcal Graphite & carbon Inc.), and Ketjenblack® (manufactured by the Ketjen Black International Company).

Here, if the particle size of the spherical conductive material 3 is less than 10 nm, it is difficult to maintain conductivity between materials due to the very small size of the material. On the other hand, if the particle size of the spherical conductive material 3 exceeds 80 nm, the spherical conductive material 3 may not be capable of surrounding the surface of sulfur and, thus, is not preferable.

According to one embodiment, Super C® is coated to surround an outer surface of a sulfur and VGCF mixture. Thus, powder, in which sulfur and a heterogeneous conductive material (VGCF, Super C®) are mixed and coated, may be formed.

In the above-described structure, since the fibrous conductive material 2, (e.g., VGCF) penetrates the inside of the sulfur powder 1 as a non-conductor, an electrical conductive path may extend within the sulfur powder 1 so that a reaction region of the powder can be enlarged and the utilization rate of sulfur can be maximized.

Also, since the spherical conductive material 3 having a nano size, (e.g., Super C®) is coated on the outer surface of sulfur in the form of a lump (i.e. aggregated sulfur powder particles) a loss of polysulfide that is typically generated during a discharge reaction may be suppressed to a high extent.

In addition, a conductive polymer protective film 4 is coated on the outer surface of the spherical conductive layer 3 which forms an outer layer of the sulfur and heterogeneous conductive material mixture-coating powder, (i.e., on the outer surface of a Super C® layer). Preferably, the conductive polymer protective film 4 is coated to a thin-film thickness of about 10 to 50 nm. By coating the conductive polymer protective film 4 using a conductive polymer, the loss of a byproduct, such as polysulfide, is further suppressed.

Here, if the thickness of the conductive polymer protection layer 4 is less than 10 nm, it is difficult to maintain the effect of a protective film due to the very small thickness. On the other hand, and if the thickness of the conductive polymer protective film 4 exceeds 50 nm, ion and electron movement is not smoothly performed and, thus, is not preferable.

The conductive polymer that may be used in coating a conductive polymer protective film of the sulfur and heterogeneous conductive material mixture-coating powder can be selected from all polymers having electrical conductivity, such as, but not limited to, poly(3,4-ethylenedioxythiophene)(PEDOT), poly(styrene sulfonate), polyacrylonitrile, polyaniline, and mixtures thereof.

Such a sulfur and heterogeneous conductive material mixture-coating powder 7 including the conductive polymer protective film 4 provides numerous advantages. In particular, the utilization rate of sulfur can be greatly increased and the conductive polymer protective film 4 suppresses the loss of polysulfide that is generated during discharge together with the spherical conductive layer. As such, the life-span c of the lithium-sulfur secondary battery can be improved.

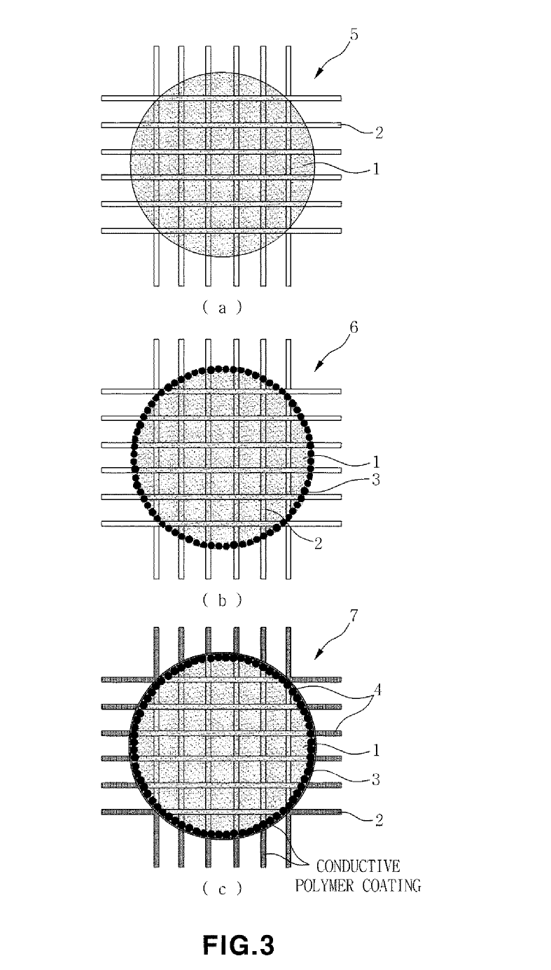

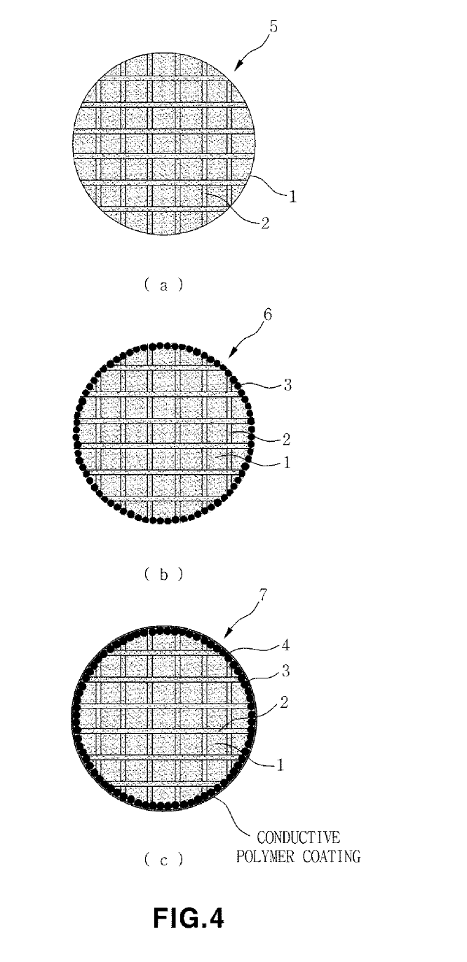

FIGS. 3 and 4 illustrate a method of fabricating the powder illustrated in FIG. 1 or 2, according to an exemplary embodiment of the present invention. FIG. 3 illustrates a method of fabricating the powder 7 of FIG. 1, and FIG. 4 illustrates a method of fabricating the powder 7 of FIG. 2.

In FIGS. 3 and 4, (a) represents a sulfur and fibrous conductive material mixture powder 5; (b) represents a sulfur and heterogeneous conductive material (a fibrous conductive material 2 and a spherical conductive material 3) mixture-coating powder 6 that is obtained by additionally coating the spherical conductive material 3; and (c) represents a sulfur and heterogeneous conductive material mixture-coating powder 7 including a conductive polymer protective film obtained by additionally coating the conductive polymer protection layer 4.

In FIG. 3, part of the fibrous conductive material 2 that is inserted into the sulfur powder 1 and connected to the sulfur powder 1, of the sulfur and heterogeneous conductive material mixture-coating powder 6 protrudes beyond an outside of the powder 7 (extends to the outside of the spherical conductive material layer). The conductive polymer protective film 4 is coated on the outer surface of the powder 7 (the outer surface of the spherical conductive material layer 3) and on the outer surface of the fibrous conductive material 2 that protrudes beyond the outside of the powder 7.

On the other hand, in FIG. 4, the fibrous conductive material 2 is inserted completely within the sulfur powder 1 of the sulfur and heterogeneous conductive material mixture-coating powder 6. In this case, the conductive polymer protective film 4 is coated only the outer surface of the powder 7 (outer surface of the spherical conductive material layer).

According to an embodiment of the present invention, in a process of mixing and coating sulfur and a heterogeneous conductive material (carbon material), a sulfur powder 1 and a fibrous conductive material 2 (for example, VGCF) in the form of a rod having a high aspect ratio are mixed using a ball mill or planetary mill. The mixing device can be any such device that provides mixture and grinding capabilities.

Thus, the ball mill or planetary mill (or other mixing device) has the effect of mixing and grinding the sulfur powder 1 and the fibrous conductive material 2. As such, the ball mill or planetary mill (or other mixing device) can be used in uniformly mixing the sulfur powder 1 and the fibrous conductive material 2 so that a mixed structure in which the fibrous conductive material 2 is inserted in the sulfur powder 1, can be formed, as illustrated in (a) of FIGS. 3 and 4.

In this case, the fibrous conductive material 2 penetrates the center of the sulfur powder 1 and is inserted therein (i.e. penetrates the interior of the sulfur powder 1). As a milling time and a rotative force are adjusted, the fibrous conductive material 2 in the form of the rod may protrude beyond the outside of the sulfur powder 1, as illustrated in FIG. 3, or may be disposed completely within the sulfur powder 1, as illustrated in FIG. 4.

Subsequently, a sulfur and fibrous conductive material mixed powder 5 prepared in this way and a spherical conductive material 3 having a nano size (for example, Super C®) are put in a coating device to which a shearing force is applied, and are coated so that a mixture-coating powder 6 in which the spherical conductive material 3 is coated on the surface of the sulfur and fibrous conductive material mixed powder 5, can be formed.

In this case, the spherical conductive material (e.g., Super C®) 3 having a nano size is uniformly coated on the entire surface of the sulfur and fibrous conductive material (VGCF) mixed powder 5 so that the entire powder 1 can be surrounded by the spherical conductive material 3. The thickness of the coating can be adjusted by varying the strength of the shearing force in this procedure.

A planetary rotor type or grinder type coating device is one example of a suitable coating device to which the shearing force may be applied. While a ball mill or planetary mill may be used in uniformly mixing sulfur and the conductive material, such devices are not suitable for making a structure in which the surface of the sulfur powder is surrounded (coated) by the conductive material.

In the planetary rotor type or grinder type coating device, as the coating time and the rotative force are adjusted, the conductive material may penetrate the surface of the sulfur powder and may be provided at a lower portion of the surface of the sulfur powder. However, the coating is carried out such that the conductive material does not thoroughly penetrate the sulfur powder in such a way that the conductive material is uniformly dispersed into the center of the sulfur powder.

Thus, as described above, the ball mill or planetary mill, instead of the planetary rotor type or grinder type coating device, is used in mixing the fibrous conductive material 2 with the sulfur powder 1 so that the fibrous conductive material 2 can penetrate into the center of the sulfur powder 1.

Next, the outer surface of the sulfur and heterogeneous conducive material mixture-coating powder 6 is coated with conducive polymer so as to form a protective film 4. As a result, a sulfur and heterogeneous conductive material (heterogeneous carbon material) mixture-coating powder 7, having an outer surface coated with the conductive polymer protection layer 4, is fabricated.

Various methods of coating conductive polymer, such as deep coating, filtration, ultraviolet (UV) hardening, spray coating, and the like, may be used.

The conductive polymer may be any polymer having well-known electrical conductivity, in addition to the above-described poly(3,4-ethylenedioxythiophene) (PEDOT), poly(styrene sulfonate), polyacrylonitrile, and polyaniline. Similar to the formation of a general polymer coating, a polymer thin film may be formed (i.e., conductive polymer protection layer 4) by performing liquid coating followed by a drying and hardening processes.

Hereinafter, the present invention will be described in greater detail based on exemplary embodiments, and aspects of the present invention are not limited thereto.

### Embodiment 1

1 g of a sulfur powder (Sigma Aldrich, 325 mesh) having a particle size of about 10 μm was prepared using a ball mill and a sieve shaker, and 0.33 g of VGCF (Showa Denko, having a length of 10 to 20 μm) was mixed therewith and then was mixed in a ball mill using a zirconia ball at 300 rpm for 12 hours to form a sulfur and VGCF mixture powder. Next, the sulfur and VGCF mixture powder was mixed with Super C® (Timcal, 40 nm) and was put in a planetary rotor coating device to which a shearing force was applied, and the planetary rotor coating device was operated at 300 rpm for 3 minutes to fabricate a sulfur and heterogeneous conductive material mixture-coating powder. Next, 5% of dimethyl sulfoxide (DMSO) was added to a poly(3,4-ethylenedioxythiophene) (PEDOT) solution, and deionized (DI) water and ethanol were added thereto so as to separately prepare a solution. 100 mg of the sulfur and heterogeneous conductive material mixture-coating powder was put in 10 mL of the prepared conductive polymer solution and was coated in a ultrasonic container at about 20 nm for 3 hours so as to fabricate a sulfur and heterogeneous conductive material mixture-coating powder having a conductive polymer protective film, as illustrated in FIG. 1.

### Embodiment 2

1 g of a sulfur powder (Sigma Aldrich, 325 mesh) having a size of about 10 μm was prepared using a ball mill and a sieve shaker, and 0.2 g of VGCF (Showa Denko, having a length of 10 to 20 μm) was mixed therewith and then was mixed in a ball mill using a zirconia ball at 600 rpm for 12 hours to form a sulfur and VGCF mixture powder. Next, the sulfur and VGCF mixture powder was mixed with Super C® (Timcal, 40 nm) and was put in a planetary rotor coating device to which a shearing force was applied, and the planetary rotor coating device was operated at 300 rpm for 1 minute to fabricate a sulfur and heterogeneous conductive material mixture-coating powder. Next, 10% of dimethyl sulfoxide (DMSO) was added to a poly(3,4-ethylenedioxythiophene) (PEDOT) solution, and DI water and ethanol were used in an amount of about 30 parts by weight, based on 100 parts by weight of the entire conductive polymer solution so as to separately prepare a solution. Next, 100 mg of the sulfur and heterogeneous conductive material mixture-coating powder was put in 10 mL of the prepared conductive polymer solution and was coated in a ultrasonic container at about 10 nm for 1 hour so as to fabricate a sulfur and heterogeneous conductive material mixture-coating powder having a conductive polymer protective film, as illustrated in FIG. 1.

When the sulfur and heterogeneous conductive material mixture-coating powder having the conductive polymer protective film fabricated based on Embodiments 1 and 2 described above are used as a cathode material of a lithium-sulfur secondary battery, a fibrous conductive material in the form of a rod having a high aspect ratio of the powder penetrates the sulfur powder so that electrical conductivity of the fibrous conductive material is exerted on the entire portion of sulfur deeply thereinto, and a powder conductive material coating layer having a nano size and a conductive polymer protective film are coated on the surface of the sulfur powder so as to suppress a loss of polysulfide. Thus, the capacity of the lithium-sulfur secondary battery can be increased and energy density and life-span characteristics thereof can be improved.

As described above, when power for a cathode of a lithium-sulfur secondary battery according to an embodiment of the present invention is used, a fibrous conductive material in the form of a rod having a high aspect ratio penetrates, and electrical conductivity of the fibrous conductive material acts deeply into sulphur, and a powder conductive material coating layer having a nano size and a conductive polymer protective film are coated on the surface of sulphur so as to suppress a loss of polysulfide such that capacity of the lithium-sulfur secondary battery can be increased and energy density and life-span characteristics thereof can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. Powder for a cathode of a lithium-sulfur secondary battery, comprising:
a fibrous conductive material inserted in a sulfur powder to penetrate the sulfur powder;
a nano sized spherical conductive material coated on an outer surface of the sulfur powder which the fibrous conductive material penetrates, such that and the spherical conductive material forms a layer surrounding the entire outer surface of the sulfur powder; and
a conductive polymer protective film is coated on an outer surface of the coated spherical conductive material layer.

2. Powder for a cathode of a lithium-sulfur secondary battery of claim 1, wherein the fibrous conductive material is inserted only in the sulfur powder.

3. Powder for a cathode of a lithium-sulfur secondary battery of claim 1, wherein at least a portion of the fibrous conductive material that is inserted in the sulfur powder and penetrates the sulfur powder, protrudes beyond an outside of the spherical conductive material layer, and wherein the conductive polymer protective film is further coated on an outer surface of the fibrous conductive material that protrudes.

4. Powder for a cathode of a lithium-sulfur secondary battery of claim 1, wherein the fibrous conductive material comprises carbon fiber having an aspect ratio of about 6 to about 600.

5. Powder for a cathode of a lithium-sulfur secondary battery of claim 4, wherein the fibrous conductive material comprises carbon fiber having a diameter of about 50 nm to about 300 nm and a length of about 2 μm to about 30 μm.

6. Powder for a cathode of a lithium-sulfur secondary battery of claim 1, wherein the fibrous conductive material comprises vapor grown carbon fiber (VGCF).

7. Powder for a cathode of a lithium-sulfur secondary battery of claim 1, wherein the spherical conductive material comprises a carbon material having a particle size of about 10 nm to about 80 nm.

8. Powder for a cathode of a lithium-sulfur secondary battery of claim 1, wherein the spherical conductive material comprises one, or two or more nano sized conductive powders selected from the group consisting of Super C®, Super P®, and Ketjenblack®.

9. Powder for a cathode of a lithium-sulfur secondary battery of claim 1, wherein a thickness of the conductive polymer protective film is about 10 nm to about 50 nm.

10. Powder for a cathode of a lithium-sulfur secondary battery of claim 3, wherein a thickness of the conductive polymer protective film is about 10 nm to about 50 nm.

11. A method of fabricating powder for a cathode of a lithium-sulfur secondary battery, the method comprising:
mixing a sulfur powder and a fibrous conductive material to fabricate a sulfur and fibrous conductive material mixture powder in which the fibrous conductive material is inserted in the sulfur powder and penetrates the sulfur powder;
coating a nano sized spherical conductive material on a surface of the sulfur powder to fabricate a sulfur and heterogeneous conductive material mixture-coating powder in which a spherical conductive material layer entirely surrounds the sulfur powder; and
coating a conducive polymer protective film on an outer surface of the spherical conductive material layer.

12. The method of claim 11, wherein the fibrous conductive material is inserted only in the sulfur powder.

13. The method of claim 11, wherein said mixing the sulfur powder and the fibrous conductive material are carried out such that at least a portion of the fibrous conductive material protrudes beyond an outside surface of the spherical conductive material layer, and wherein the conductive polymer protective film is further coated on a outer surface of the fibrous conductive material that protrudes.

14. The method of claim 11, wherein, when the sulfur and fibrous conductive material mixture powder is fabricated, the sulfur powder and the fibrous conductive material are mixed using a ball mill or planetary mill.

15. The method of claim 11, wherein the sulfur and heterogeneous conductive material mixture-coating powder is fabricated using a coating device to which a shearing force is applied.

16. The method of claim 16, wherein the coating device comprises a planetary rotor type or grinder type coating device.

17. The method of claim 11, wherein the fibrous conductive material comprises carbon fiber having an aspect ratio of about 6 to about 600.

18. The method of claim 17, wherein the fibrous conductive material comprises carbon fiber having a diameter of about 50 nm to about 300 nm and a length of about 2 μm to about 30 μm.

19. The method of claim 11, wherein the fibrous conductive material comprises vapor grown carbon fiber (VGCF).

20. The method of claim 11, wherein the spherical conductive material comprises a carbon material having a particle size of about 10 nm to about 80 nm.

21. The method of claim 11, wherein the spherical conductive material is one, or two or more conductive powder having a nano size selected from the group consisting of Super C®, Super P®, and Ketjenblack®.

22. The method of claim 11, wherein the conductive polymer protective film is coated to a thickness of about 10 nm to about 50 nm.

23. The method of claim 12, wherein the conductive polymer protective film is coated to a thickness of about 10 nm to about 50 nm.
